(19) United States
(12) Patent Application Publication
(10) Pub. No.: US 2023/0099314 A1
(43) Pub. Date: Mar. 30, 2023

(54) MOTOR UNIT AND ELECTRIC BICYCLE

(71) Applicant: Panasonic Intellectual Property Management Co., Ltd., Osaka (JP)

(72) Inventors: Shigeru IDO, Osaka (JP); Masafumi KAWAKAMI, Nara (JP); Takanori NAKANO, Nara (JP)

(21) Appl. No.: 17/947,132

(22) Filed: Sep. 18, 2022

(30) Foreign Application Priority Data
Sep. 29, 2021 (JP) 2021-159711

(51) Int. Cl. B62M 6/50; B62M 6/55

(52) U.S. Cl. CPC B62M 6/50; B62M 6/55

(57) ABSTRACT

A motor unit for use in an electric bicycle includes a motor, a switching element, a board, and a case. The switching element has the motor driven. The board has a principal surface and a reverse surface. The principal surface includes a mounting surface to mount the switching element thereon. The reverse surface faces opposite from the principal surface. The case houses the board therein. The board further has a through hole provided to penetrate through the board from the mounting surface through the reverse surface and a sheet of metal foil covering an inner peripheral surface of the through hole at least partially. The switching element is thermally connected to the sheet of metal foil. A part, located opposite from the switching element with respect to the board, of the case is thermally connected to the sheet of metal foil.

### CROSS-REFERENCE TO RELATED APPLICATIONS

The present application is based upon, and claims the benefit of priority to, Japanese Patent Application No. 2021-159711, filed on Sep. 29, 2021, the entire contents of which are hereby incorporated by reference.

### TECHNICAL FIELD

The present disclosure relates to a motor unit and an electric bicycle.

### BACKGROUND ART

An electric bicycle including a motor unit has been known. The motor unit includes a motor, a board on which various types of electronic components are mounted to control the motor, and a case that houses the motor and the board therein.

As for this type of electric bicycles, it has been proposed in the art that some electronic components, such as switching elements, which generate a significant quantity of heat among the various electronic components be thermally connected to the case (see, for example, JP 2007-176354 A). This increases the quantity of heat dissipated from the electronic components.

### SUMMARY

The present disclosure contributes to improving the reliability of a motor unit by further increasing the quantity of heat dissipated from a switching element included in the motor unit.

A motor unit according to an aspect of the present disclosure is designed to be used in an electric bicycle. The motor unit includes a motor, a switching element, a board, and a case. The switching element has the motor driven. The board has a principal surface and a reverse surface. The principal surface includes a mounting surface to mount the switching element thereon. The reverse surface faces opposite from the principal surface. The case houses the board therein. The board further has a through hole provided to penetrate through the board from the mounting surface through the reverse surface and a sheet of metal foil covering an inner peripheral surface of the through hole at least partially. The switching element is thermally connected to the sheet of metal foil. A part, located opposite from the switching element with respect to the board, of the case is thermally connected to the sheet of metal foil.

This aspect enables improving the reliability of the motor unit by further increasing the quantity of heat dissipated from a switching element included in the motor unit.

A motor unit according to another aspect preferably further includes solder to fix the switching element onto the mounting surface. The switching element is thermally connected to the sheet of metal foil via the solder.

This aspect enables efficiently transferring, via the solder having thermal conductivity, the heat generated by the switching element.

A motor unit according to still another aspect preferably further includes an insulating member provided on the reverse surface to cover the through hole at least partially.

This aspect enables reducing the outflow of the solder through the through hole.

In a motor unit according to yet another aspect, the through hole preferably has a diameter falling within a range from 0.2 mm to 0.4 mm.

This aspect enables efficiently transferring, via the sheet of metal foil inside the through hole, the heat generated by the switching element.

In a motor unit according to yet another aspect, the through hole preferably has a diameter falling within a range from 0.2 mm to 0.35 mm.

This aspect enables efficiently transferring, via the sheet of metal foil inside the through hole, the heat generated by the switching element.

In a motor unit according to yet another aspect, the motor is preferably located on the same side as the switching element with respect to the board.

This aspect enables dissipating, to the other side opposite from the motor with respect to the board, the heat generated by the switching element.

In a motor unit according to yet another aspect, the switching element preferably includes a single field effect transistor and a package covering the single field effect transistor.

This aspect enables providing a switching element with excellent heat dissipation properties.

In a motor unit according to yet another aspect, the switching element preferably includes a plurality of field effect transistors and a package covering the plurality of field effect transistors.

This aspect allows implementing the switching element as an element with a reduced size.

In a motor unit according to yet another aspect, the sheet of metal foil preferably has a thickness falling within a range from 10 μm to 30 μm.

This aspect enables efficiently transferring, via the sheet of metal foil, the heat generated by the switching element.

In a motor unit according to yet another aspect, the mounting surface is preferably located in an end region of the board.

This aspect makes it easier to thermally connect the switching element to a part of the case and secure a path to dissipate the heat from the switching element to the case.

In a motor unit according to yet another aspect, the board preferably includes a base member made of a thermally conductive material.

This aspect enables efficiently transferring, via the base member, the heat generated by the switching element.

In a motor unit according to yet another aspect, a part, located on the same side as the switching element with respect to the board, of the case is preferably thermally connected to the switching element.

This aspect enables thermally connecting respective parts, located on one and the other sides with respect to the switching element, of the case to the switching element, thus further increasing the quantity of heat dissipated from the switching element.

In a motor unit according to yet another aspect, the board preferably includes a metal layer and a resist layer covering the metal layer. The metal layer is thermally connected to the sheet of metal foil. The resist layer is arranged to expose a part of the metal layer. A heat-dissipating solder portion is fixed to the part of the metal layer.

This aspect enables further increasing the quantity of heat dissipated from the switching element.

In a motor unit according to yet another aspect, the through hole preferably has an opening and the switching element preferably faces the opening.

This aspect enables efficiently transferring, via the sheet of metal foil inside the through hole, the heat generated by the switching element.

A motor unit according to yet another aspect preferably further includes two or more electric field capacitors mounted on the board.

This aspect provides two or more electric field capacitors, and therefore, allows the electric field capacitors to be arranged with an increased degree of freedom on the board, thus enabling using the space inside the case more effectively.

A motor unit according to yet another aspect preferably further includes an inertial sensor and/or a microcontroller which are/is mounted on a first half of the board. The mounting surface is located in a second half of the board.

This aspect may reduce the chances of the electrical noise generated by the switching element affecting the inertial sensor and/or the microcontroller.

A motor unit according to yet another aspect preferably further includes a microcontroller mounted on the board. The microcontroller is arranged not to overlap with the motor when viewed along a center axis of rotation of the motor.

This aspect may reduce the chances of the electrical noise generated by the motor affecting the microcontroller.

A motor unit according to yet another aspect preferably further includes a single-stage speed reducer coupled to the motor.

This aspect enables outputting the rotational power of the motor with the speed reduced in a single stage.

A motor unit according to yet another aspect preferably further includes a double-stage speed reducer coupled to the motor.

This aspect enables outputting the rotational power of the motor with the speed reduced in two stages.

A motor unit according to yet another aspect preferably further includes a triple-stage speed reducer coupled to the motor.

This aspect enables outputting the rotational power of the motor with the speed reduced in three stages.

A motor unit according to yet another aspect preferably includes: an input shaft, to which crank arms are coupled and which is rotatable; a first output body, to which a first sprocket is coupled and which is rotatable; and a second output body, to which a second sprocket is coupled and which is rotatable. The first output body is configured to receive rotational power transmitted from the input shaft. The second output body is configured to receive rotational power transmitted from the motor.

This aspect enables providing a so-called “biaxial motor unit.”

A motor unit according to yet another aspect preferably includes: an input shaft, to which crank arms are coupled and which is rotatable; and an output body, to which a sprocket is coupled and which is rotatable. The output body is configured to receive rotational power transmitted from the input shaft and rotational power transmitted from the motor.

This aspect enables providing a so-called “uniaxial motor unit.”

A motor unit according to an alternative aspect of the present disclosure is designed to be used in an electric bicycle. The motor unit includes a motor, a switching element, a board, a case, and a heat-dissipating portion. The switching element has the motor driven. The board has a principal surface and a reverse surface. The principal surface includes a mounting surface to mount the switching element thereon. The reverse surface faces opposite from the principal surface. The case houses the board therein. The heat-dissipating portion is interposed between the switching element and the case to transfer heat generated by the switching element to an outer surface of the case. The board includes: an insulating layer forming the reverse surface; and a metal layer covered with the insulating layer. The insulating layer is arranged to expose a part of the metal layer. The part of the metal layer is provided with a metallic projection protruding away from the board.

This aspect enables improving the reliability of the motor unit by further increasing the quantity of heat dissipated from a switching element included in the motor unit.

In a motor unit according to the alternative aspect, the heat-dissipating portion preferably includes a first heat-dissipating portion thermally connected to the metallic projection via a thermally conductive member.

This aspect enables efficiently dissipating the heat from the switching element via the thermally conductive member, the first heat-dissipating portion, and the metallic projection.

In a motor unit according to the alternative aspect, the metallic projection is preferably arranged to overlap with the switching element when viewed perpendicularly to the reverse surface.

This aspect enables efficiently dissipating the heat from the switching element via the metallic projection.

In a motor unit according to the alternative aspect, the heat-dissipating portion preferably includes a second heat-dissipating portion thermally connected to the switching element via a thermally conductive member.

This aspect enables efficiently dissipating the heat from the switching element via the thermally conductive member and the second heat-dissipating portion.

In a motor unit according to the alternative aspect, at least part of the heat-dissipating portion is preferably provided separately from the case.

This aspect enables increasing the freedom of design of the heat-dissipating portion.

An electric bicycle according to yet aspect of the present disclosure includes: the motor unit described above; a wheel to which rotational power is transmitted from the motor; a frame supporting the motor unit and the wheel; a heat-dissipating portion configured as a part, thermally connected to the switching element, of the case; and an input shaft, to which crank arms are coupled and which is rotatable. The heat-dissipating portion is located, in a side view, under a line that connects together respective center axes of rotation of the input shaft and the motor.

This aspect enables improving the reliability of the motor unit by further increasing the quantity of heat dissipated from a switching element included in the motor unit.

An electric bicycle according to an alternative aspect of the present disclosure includes the motor unit described above, a wheel to which rotational power is transmitted from the motor, and a frame supporting the motor unit and the wheel.

This aspect enables improving the reliability of the motor unit by further increasing the quantity of heat dissipated from a switching element included in the motor unit.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a side view of an electric bicycle according to an exemplary embodiment;

FIG. 2 is a side view of a principal part of the electric bicycle;

FIG. 3 is a schematic cross-sectional view of a motor unit included in the electric bicycle;

FIG. 4 is a cross-sectional view illustrating, in further detail, the portion P shown in FIG. 3;

FIG. 5 is a side view of a board included in the motor unit;

FIG. 6 is another side view of the board;

FIG. 7 is a side view illustrating the motor unit with a part thereof removed;

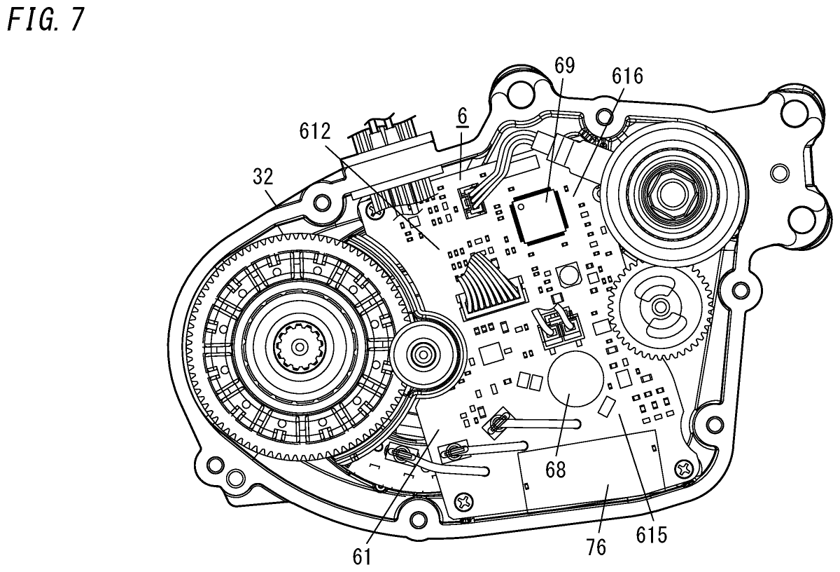

FIG. 8 is a side view illustrating a second divided part of a case included in the motor unit;

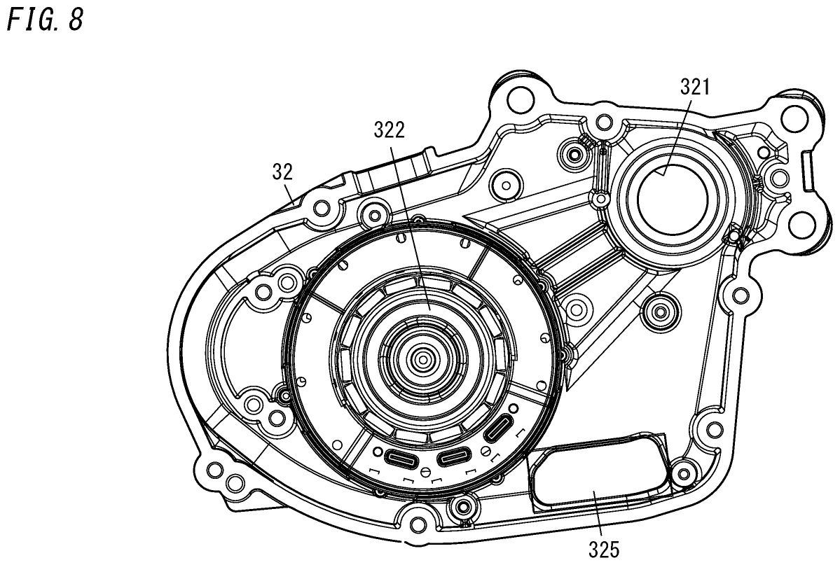

FIG. 9 is a cross-sectional view illustrating a principal part of the motor unit according to a first variation;

FIG. 10 is a cross-sectional view illustrating a principal part of the motor unit according to a second variation;

FIG. 11 is a cross-sectional view illustrating a principal part of the motor unit according to a third variation;

FIG. 12 is a schematic cross-sectional view of the motor unit according to a fourth variation;

FIG. 13 is a cross-sectional view illustrating, in further detail, the portion Q shown in FIG. 12;

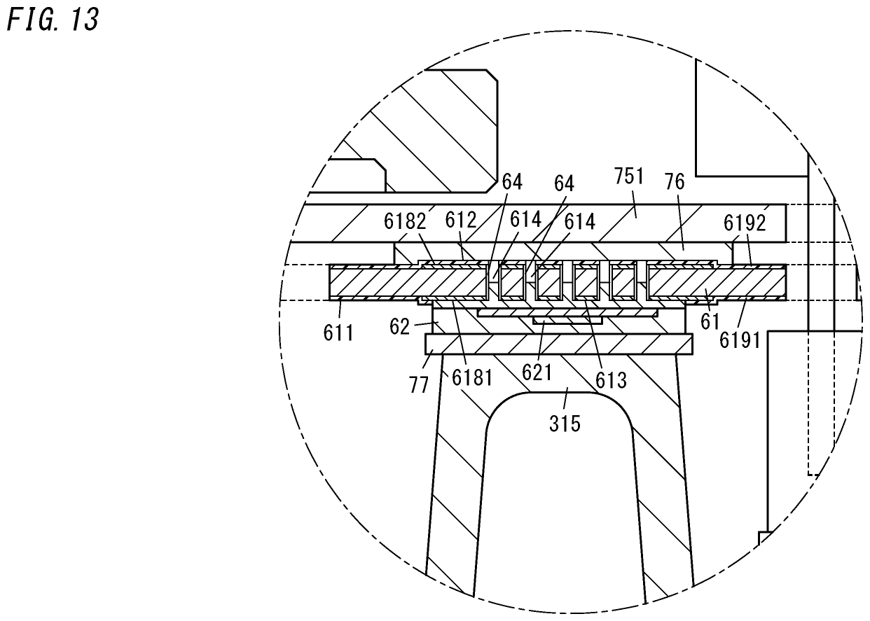

FIG. 14 is a cross-sectional view illustrating a principal part of a motor unit according to an alternative embodiment; and

FIG. 15 is a cross-sectional view illustrating a principal part of a motor unit according to a variation of the alternative embodiment.

### DETAILED DESCRIPTION

### (1) Exemplary Embodiment

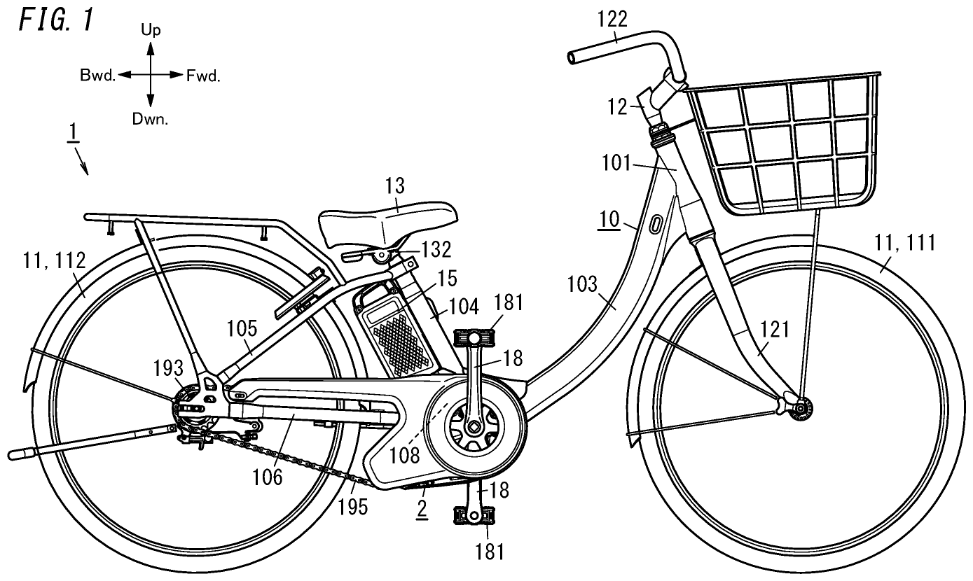

An electric bicycle 1 according to an exemplary embodiment is implemented as an electric assist bicycle. As shown in FIG. 1, the electric bicycle 1 includes: a frame 10; a motor unit 2 which is supported and mounted on the frame 10; and two wheels 11 which are rotatably supported by the frame 10. The two wheels 11 are a front wheel 111 and a rear wheel 112. The rear wheel 112 is driven in rotation by the driving force supplied from the motor unit 2 (i.e., upon receiving the rotational power of the motor 4 included in the motor unit 2).

Note that in the following description, the respective directions, including the forward/backward directions, the rightward/leftward directions, and the upward/downward direction, are herein defined with respect to the rider of the electric bicycle 1. Specifically, the direction in which the rider who is riding the electric bicycle 1 travels by pedaling the electric bicycle 1 is the forward direction, and the opposite direction thereof is the backward direction. The direction pointing to the left when viewed from the rider is the leftward direction, and the direction pointing to the right when viewed from him or her is the rightward direction. The respective constituent elements thereof will be described in detail.

(1.1) Frame

The frame 10 includes a head tube 101, a down tube 103, a seat tube 104, seat stays 105, chain stays 106, and a bracket 108.

The frame 10 (i.e., the respective parts that form the frame 10) is typically made of a metal such as aluminum or stainless steel, which may contain a non-metallic material as well. Alternatively, the entire frame 10 may also be made of a non-metallic material. Thus, the frame 10 may be made of any material without limitation.

A handlebar stem 12 is inserted rotatably into the head tube 101. At the bottom of the handlebar stem 12, provided is a fork 121, on which the front wheel 111 is mounted rotatably. To the top portion of the handlebar stem 12, fixed are handlebars 122.

Into a hole at the top of the seat tube 104, inserted is a tube 132 extending downward from a saddle 13. Fixing the tube 132 into the seat tube 104 allows the saddle 13 to be fixed. The bottom portion of the seat tube 104 is fixed to the bracket 108.

A front end portion of the down tube 103 is further fixed to the head tube 101. A rear end portion of the down tube 103 is fixed to the bracket 108.

To the bracket 108, fixed is the motor unit 2. To a rear end portion of the bracket 108, fixed are respective frontend portions of the chain stays 106.

To an upper end portion of the seat tube 104, fixed are respective frontend portions of the seat stays 105. The respective rear end portions of the seat stays 105 are coupled to the respective rear end portions of the chain stays 106. The rear wheel 112 is mounted rotatably on their coupling portions. On the seat tube 104, a battery 15 for supplying power to the motor unit 2 is mounted removably.

(1.2) Motor Unit

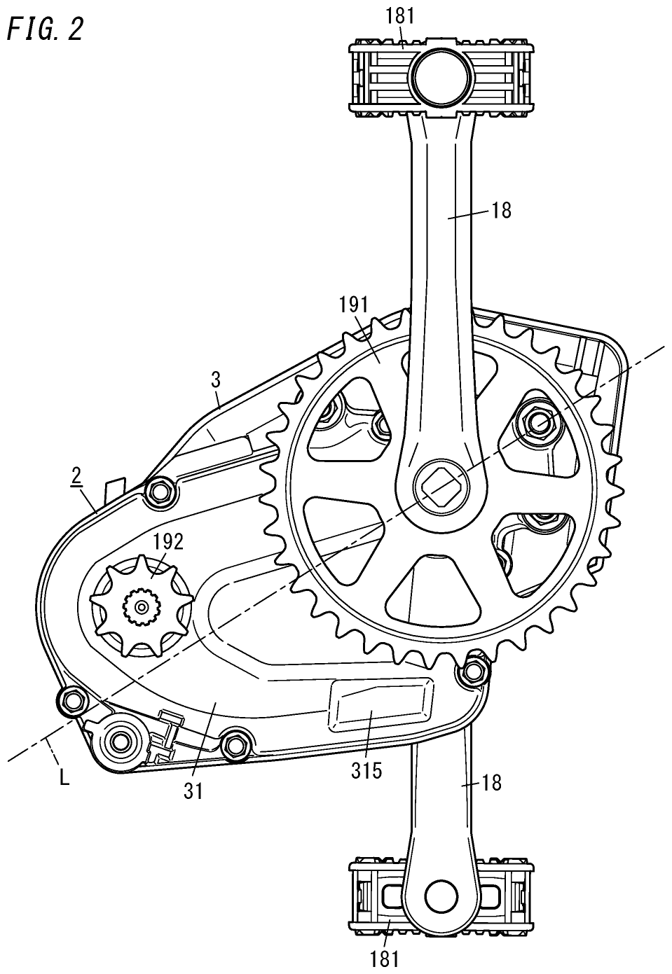

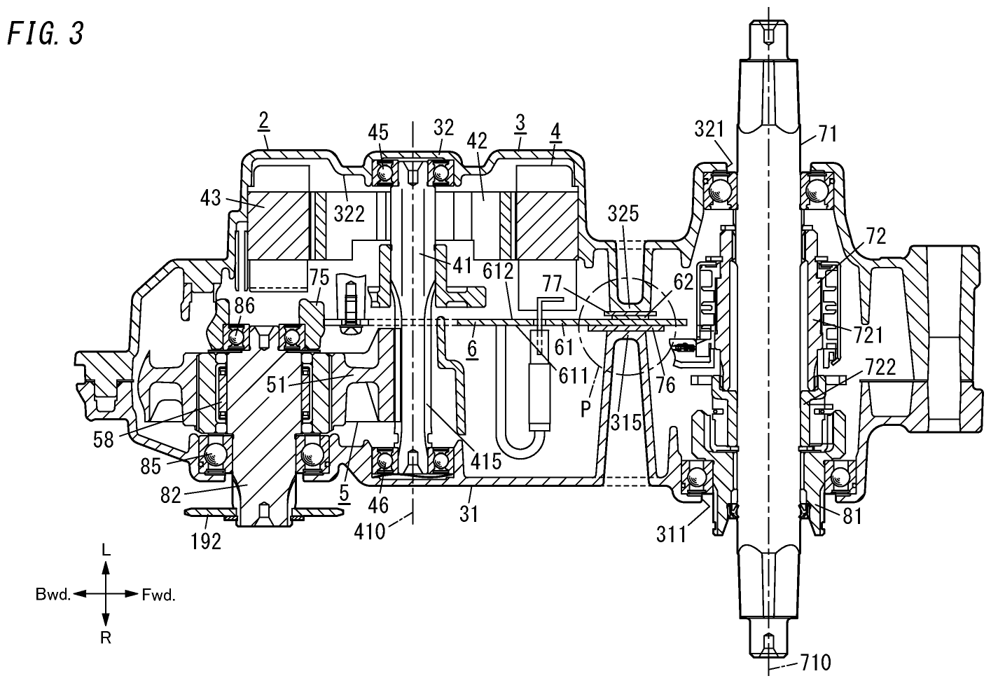

As shown in FIGS. 2 and 3, the majority of the shell of the motor unit 2 is formed by a case 3. A motor 4, operating as a drive source for driving the wheels 11 in rotation, is fitted into the case 3. The case 3 houses a speed reducer 5 coupled to the motor 4 such that the rotational power of the motor 4 may be transmitted thereto and a control board 6 for controlling the rotation of the motor 4. The case 3 further houses an input shaft 71, an input body 72, output bodies 81, 82, and other members.

The case 3 includes a first divided part 31 forming a half of the case 3 on a first side and a second divided part 32 forming a half of the case 3 on a second side. The first side is the right side for the electric bicycle 1 according to the exemplary embodiment. The second side is opposite from the first side and is the left side for the electric bicycle 1 according to the exemplary embodiment. A hollow case 3 is formed by joining together the first divided part 31 on the right side and the second divided part 32 on the left side.

The first divided part 31 has a space which is opened to the left. This space forms the right half of the housing space of the case 3. The second divided part 32 has a space which is opened to the right. This space forms the left half of the housing space of the case 3. The second divided part 32 has a recess 322 in which the motor 4 is installed. The first divided part 31 and the second divided part 32 are joined together such that their respective spaces communicate with each other.

The motor 4 includes: a circular columnar rotary shaft 41; a rotor 42 coupled to the rotary shaft 41 to rotate along with the rotary shaft 41; and a circular cylindrical stator 43 arranged to surround the rotor 42.

On the inner bottom surface of the recess 322, disposed is a bearing 45. The bearing 45 is provided to rotatably support one axial end portion of the rotary shaft 41. The other axial end portion of the rotary shaft 41 is rotatably supported by another bearing 46 disposed on the inner surface of the first divided part 31. On the outer peripheral surface of a part, protruding from the rotor 42, of the rotary shaft 41, provided are teeth 415 to mesh with the speed reducer 5.

In the case 3, the input shaft 71 is housed to be rotatable around an axis 710 thereof. The first divided part 31 has a through hole 311 into which the input shaft 71 is inserted. The second divided part 32 also has a through hole 321 into which the input shaft 71 is inserted.

To both end portions of the input shaft 71, fixed are crank arms 18 (see, for example, FIG. 2). To the tip portion of each of these crank arms 18, attached rotatably is a pedal 181. The rider may apply manual rotational force to the input shaft 71 by pumping the pedals 181.

In the case 3, the input body 72 is arranged along the outer peripheral surface of the input shaft 71. The input body 72 is a cylindrical member and rotates along with the input shaft 71.

The input body 72 includes a first input body 721 and a second input body 722. The first input body 721 is coupled to the input shaft 71. The second input body 722 is coupled to the first input body 721. The second input body 722 is configured to transmit rotational power to the output body 81.

The output body 81 is a cylindrical member and is arranged rotatably along the outer peripheral surface of the input shaft 71. One end portion of the output body 81 passes through the through hole 311 of the first divided part 31 to protrude out of the case 3. A front sprocket 191 is fixed to the portion, protruding out of the case 3, of the output body 81 (see FIG. 2). The front sprocket 191 rotates along with the output body 81.

In the electric bicycle 1 according to this exemplary embodiment, the motor unit 2 further includes an output body 82, which is provided separately from the output body 81. The output body 82 is a member to be driven in rotation by the rotational power of the motor 4. In the following description, the output body 81 to be driven in rotation by the manual rotational force will be hereinafter referred to as a “first output body 81” and the output body 82 to be driven in rotation by the rotational power of the motor 4 will be hereinafter referred to as a “second output body 82” to make these two output bodies 81, 82 distinguishable from each other.

A first end portion of the second output body 82 is located inside the case 3. The second output body 82 is supported rotatably by a bearing 85 disposed in the first divided part 31 and a bearing 86 disposed in a retainer 75.

The retainer 75 is a metallic member housed in the case 3. The retainer 75 is preferably made of either aluminum or an aluminum alloy. Alternatively, the retainer 75 may also be made of a magnesium alloy, a ferrous metal, or a resin. The retainer 75 is arranged to overlap at least partially with the motor 4 when viewed along the axis 410 of the rotary shaft 41 of the motor 4.

A second end portion of the second output body 82 protrudes out of the case 3. Another sprocket 192 on the front side is fixed to the second end portion of the second output body 82. The sprocket 192 rotates along with the second output body 82. In the following description, the sprocket 191 will be hereinafter referred to as a “first sprocket 191” and the sprocket 192 will be hereinafter referred to as a “second sprocket 192” to make these sprockets 191, 192 distinguishable from each other.

Between the second output body 82 and the rotary shaft 41 of the motor 4, disposed is a speed reducer 5 to reduce the number of revolutions of the motor 4 and transmit reduced rotational power to the second output body 82. The speed reducer 5 is a so-called “single-stage speed reducer.” Specifically, a transmission gear 51 is mounted, via a one-way clutch 58, on the outer peripheral surface of the second output body 82. The transmission gear 51 meshes with the teeth 415 of the rotary shaft 41 of the motor 4.

A chain 195 is hung around the first and second sprockets 191, 192 on the front side and a sprocket 193 on the rear side. The rotational power of the second output body 82 is finally transmitted to the rear wheel 112 via the second sprocket 192, the chain 195, and the rear sprocket 193.

In the electric bicycle 1 according to this exemplary embodiment, when the rotary shaft 41 of the motor 4 starts rotating while the electric bicycle 1 is propelled by the manual rotational force generated by the rider who is pumping the pedals 181, the transmission gear 51 starts turning in synch with the rotary shaft 41 of the motor 4. This rotational power is transmitted via the one-way clutch 58 to the second output body 82 and then to the chain 195.

(1.3) Control Board

The control board 6 housed in the case 3 of the motor unit 2 will be described in further detail.

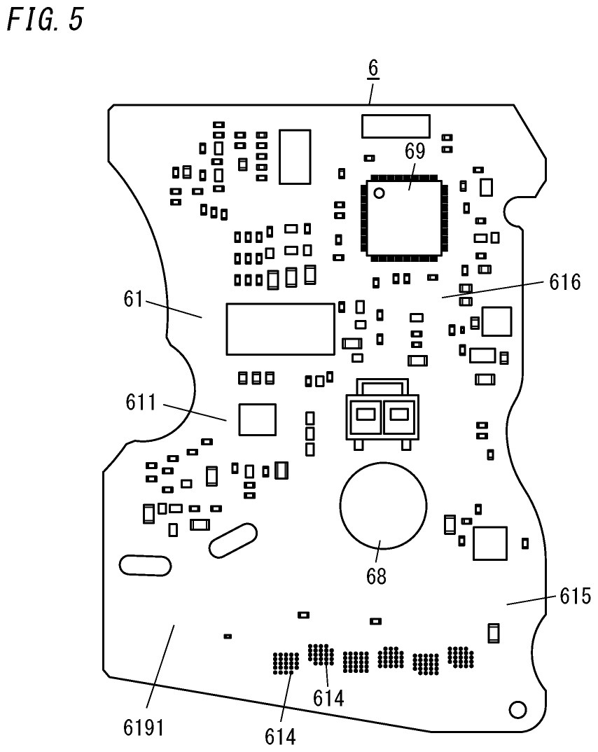

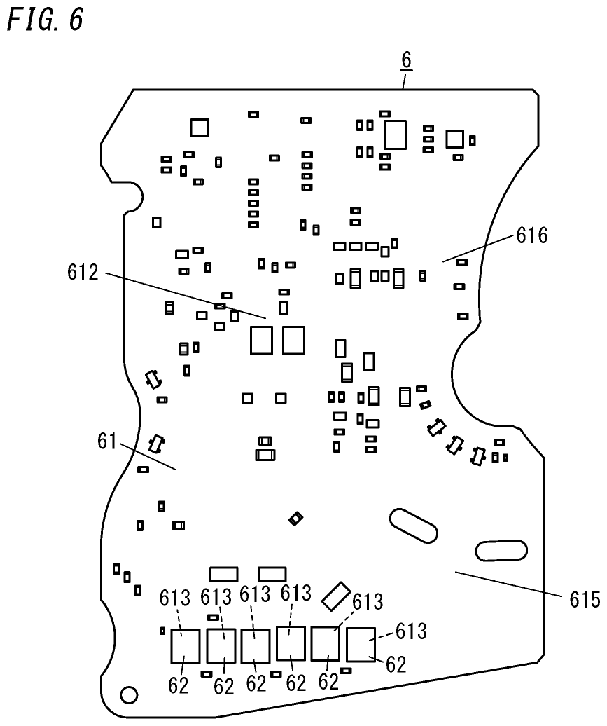

The control board 6 is formed by mounting various types of electronic components on a flat-plate board 61. The various electronic components include a plurality of switching elements 62, an electric field capacitor 68, and a microcontroller 69 (see FIGS. 5 and 6). The plurality of switching elements 62 are controlled by the microcontroller 69.

The board 61 has a first surface 611 facing to the right (i.e., to the first side) and a second surface 612 facing to the left (i.e., to the second side). The first surface 611 and the second surface 612 are a pair of surfaces that are opposite from each other. In other words, the first surface 611 and the second surface 612 are a pair of surfaces respectively serving as a principal surface and a reverse surface of the board 61. The first surface 611 and the second surface 612 are a pair of flat surfaces that are parallel to each other.

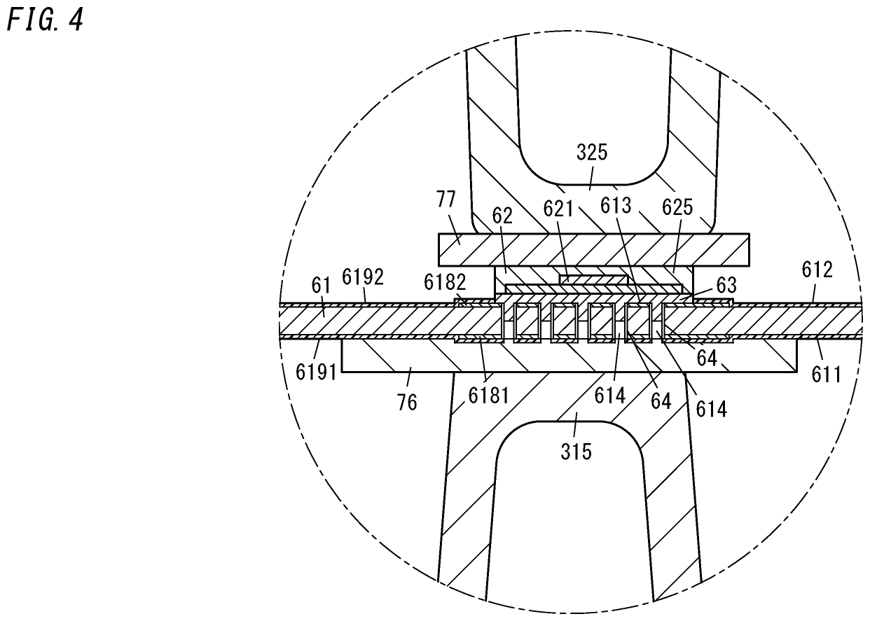

As shown in FIG. 4, the board 61 includes: an outermost resist layer 6191 that defines the first surface 611; a metal layer 6181 covered with the resist layer 6191; an outermost resist layer 6192 that defines the second surface 612; and a metal layer 6182 covered with the resist layer 6192.

The second surface 612 includes mounting surfaces 613 to respectively mount the switching elements 62 thereon. That is to say, in the motor unit 2 according to this exemplary embodiment, the second surface 612 is the principal surface including the mounting surfaces 613 to mount the switching elements 62 thereon, and the first surface 611 is the reverse surface facing opposite from the principal surface including the mounting surfaces 613.

The mounting surfaces 613 are located in an end region of the second surface 612. The switching elements 62 are fixed to the respective mounting surfaces 613 via solder 63 having thermal conductivity (see FIG. 4). In the state where the switching elements 62 are mounted on the board 61 (hereinafter simply referred to as a “mounting state”), the solder 63 is entirely in contact with the switching elements 62 and thermally connected to the switching elements 62.

As used herein, if two members are thermally connected to each other, this means that the two members are ready to transfer heat between themselves. Also, two members may also be thermally connected to each other even if another member is interposed between the two members. Examples of such situations include a situation where an insulating member in the shape of a film is interposed between the two members, a situation where a resist layer is interposed between the two members, and a situation where the insulating member in the shape of a film and the resist layer are interposed between the two members.

The switching elements 62 each include a field effect transistor 621 and a package 625 that covers the field effect transistor 621. In this embodiment, the package 625 is made of a molding resin that encapsulates the field effect transistor 621. However, this is only an example and should not be construed as limiting. Alternatively, the package 625 may also be implemented as a metallic case.

The board 61 further has a plurality of through holes 614 that improves the heat dissipation properties of each of the switching elements 62 and a sheet of metal foil 64 that covers the inner peripheral surface of each through hole 614.

Each through hole 614 is provided to penetrate through the board 61 from the first surface 611 through the second surface 612. More specifically, each through hole 614 is provided to run, over the shortest distance, between the mounting surface 613 in the end region of the second surface 612 and an end region of the first surface 611. The through hole 614 is a circular through hole and has a circular opening provided through the mounting surface 613 and another circular opening provided through the first surface 611.

The through holes 614 preferably have a diameter falling within the range from 0.2 mm to 0.4 mm and more preferably have a diameter falling within the range from 0.2 mm to 0.35 mm. In other words, the respective openings of the through holes 614 on the mounting surface 613 preferably have a diameter falling within the range from 0.2 mm to 0.4 mm and more preferably have a diameter falling within the range from 0.2 mm to 0.35 mm. Likewise, the respective openings of the through holes 614 on the first surface 611 preferably have a diameter falling within the range from 0.2 mm to 0.4 mm and more preferably have a diameter falling within the range from 0.2 mm to 0.35 mm.

The sheet of metal foil 64 may be, for example, a sheet of copper foil and has high thermal conductivity. The sheet of metal foil 64 preferably has a thickness falling within the range from 10 μm to 30 μm. The sheet of metal foil 64 covers the inner peripheral surface of the through holes 614 at least partially. The sheet of metal foil 64 preferably covers the inner peripheral surface of the through holes 614 entirely but may cover the inner peripheral surface of the through holes 614 only partially. In the mounting state, each switching element 62 faces the respective openings of the through holes 614 on the mounting surface 613. In addition, in the mounting state, each switching element 62 is thermally connected to the sheet of metal foil 64 via the solder 63. Furthermore, in the mounting state, the solder 63 is preferably in contact with the sheet of metal foil 64.

In the motor unit 2 included in the electric bicycle 1 according to this exemplary embodiment, the first divided part 31 and second divided part 32 of the case 3 preferably have, as their integral parts, portions 315, 325 that promote the heat dissipation of the switching elements 62. These portions 315, 325 may dissipate heat by being exposed to the outside air. In the following description, these portions 315, 325 will be hereinafter referred to as heat-dissipating portions 315, 325.

The heat-dissipating portion 315 of the first divided part 31 is configured as the bottom of an inwardly recessed portion (i.e., a portion recessed to the left) of the first divided part 31.

Inside the case 3, a thermally conductive member 76 having the shape of a sheet with flexibility is housed to be interposed between the heat-dissipating portion 315 and the board 61. The thermally conductive member 76 preferably contacts with the heat-dissipating portion 315 from the left-hand side thereof and preferably contacts with a part, located opposite from the mounting surface 613, of the first surface 611 of the board 61 from the right-hand side thereof. The sheet of metal foil 64 inside the respective through holes 614 of the board 61 is thermally connected to the heat-dissipating portion 315 via the thermally conductive member 76. The sheet of metal foil 64 is preferably in contact with the thermally conductive member 76. In the motor unit 2 according to this exemplary embodiment, the heat-dissipating portion 315 is the part that is located opposite from each switching element 62 with respect to the board 61 and that is thermally connected to the sheet of metal foil 64.

The heat-dissipating portion 325 of the second divided part 32 is configured as the bottom of an inwardly recessed portion (i.e., a portion recessed to the right) of the second divided part 32.

Inside the case 3, a thermally conductive member 77 having the shape of a sheet with flexibility is housed to be interposed between the heat-dissipating portion 325 and each switching element 62. The thermally conductive member 77 preferably contacts with the heat-dissipating portion 325 from the right-hand side thereof and preferably contacts with the package 625 of the switching element 62 from the left-hand side thereof. The switching element 62 is thermally connected to the heat-dissipating portion 325 via the thermally conductive member 77. In the motor unit 2 according to this exemplary embodiment, the heat-dissipating portion 325 is the part, which located on the same side as the switching element 62 with respect to the board 61, of the case 3 and which is thermally connected to the switching element 62. The switching element 62 is sandwiched between the board 61 and the heat-dissipating portion 325 via the thermally conductive member 77.

Thus, in the motor unit 2 included in the electric bicycle 1 according to this exemplary embodiment, each switching element 62 is thermally connected to the sheet of metal foil 64 provided for the respective through holes 614 of the board 61 from the left-hand side thereof (i.e., from the second side) and the heat-dissipating portion 315 forming part of the case 3 is also thermally connected to the sheet of metal foil 64 from the right-hand side thereof (i.e., from the first side). This allows the heat generated by the switching element 62 to be efficiently transferred to the heat-dissipating portion 315 via the thermally conductive sheet of metal foil 64 provided at multiple points and eventually dissipated into the outside air via the heat-dissipating portion 315.

In addition, in the motor unit 2 included in the electric bicycle 1 according to this exemplary embodiment, the heat-dissipating portion 325 forming another part of the case 3 is also thermally connected to each switching element 62 from the left-hand side thereof (i.e., from the second side). This allows the heat generated by the switching element 62 to be transferred to the heat-dissipating portion 325 as well and eventually dissipated into the outside air via the heat-dissipating portion 325.

In addition, in the motor unit 2 included in the electric bicycle 1 according to this exemplary embodiment, the switching elements 62 and the microcontroller 69 are mounted on the board 61 to be sufficiently spaced from each other. This may reduce the chances of the electrical noise generated by the switching elements 62 affecting the microcontroller 69.

Specifically, the mounting surfaces 613 on which the switching elements 62 are mounted are provided on a first half 615 of the board 61 that forms the lower half thereof (see FIG. 6). The switching elements 62 are mounted on the first half 615 of the board 61. On the other hand, the microcontroller 69 is mounted on a second half 616 of the board 61 that forms the upper half thereof (see FIG. 5). In this case, the upward/downward directions are defined with reference to the state where the electric bicycle 1 including the motor unit 2 is driven. The distance in the upward/downward direction between the microcontroller 69 and the switching elements 62 is preferably a half or more of the dimension of the board 61 as measured in the upward/downward direction.

Also, to reduce the chances of the electrical noise generated by the motor 4 affecting the microcontroller 69, either the entire microcontroller 69 or at least a central chip thereof is preferably arranged not to overlap with the motor 4 when viewed along the center axis of rotation of the motor 4 (i.e., when viewed along the axis 410 of the rotary shaft 41).

Furthermore, in the motor unit 2 included in the electric bicycle 1 according to this exemplary embodiment, the switching elements 62 are mounted on an end region of the board 61. This makes it easier to thermally connect the switching elements 62 to the parts of the case 3 (i.e., the heat-dissipating portions 315, 325) and secure a path for dissipating the heat from the switching elements 62 to the case 3.

Furthermore, as shown in FIG. 2 and other drawings, in the electric bicycle 1 according to this exemplary embodiment, the parts, thermally connected to the switching elements 62, of the case 3 (i.e., the heat-dissipating portions 315, 325) are located, in a side view, under the line that connects the respective center axes of rotation of the input shaft 71 and the motor 4 (as indicated by the on-dot chain in FIG. 2). This allows the heat generated by the switching elements 62 to be efficiently dissipated through the heat-dissipating portions 315, 325. As used herein, the “side view” refers to a situation where the electric bicycle 1 is viewed along the center axis of rotation of the motor 4 (in other words, when the electric bicycle 1 is viewed along the center axis of rotation of the input shaft 71).

(1.4) Variations

Next, variations of the electric bicycle 1 according to the exemplary embodiment will be enumerated one after another. In the following description, any constituent element of those variations, having the same function as a counterpart of the exemplary embodiment described above, will be designated by the same reference numeral as that counterpart's, and a detailed description thereof will be omitted herein.

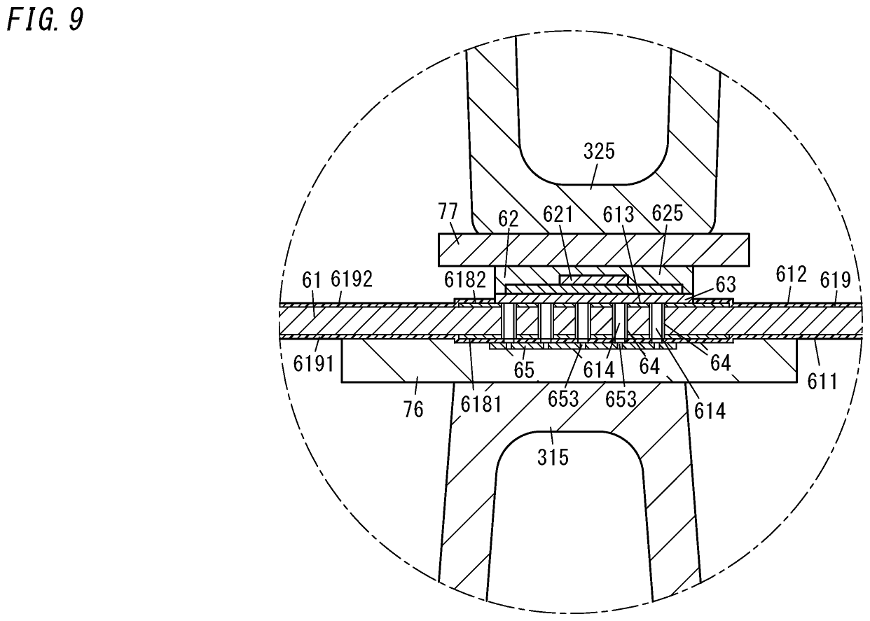

FIG. 9 illustrates a cross section of a principal part of a motor unit 2 according to a first variation. This principal part corresponds to the part shown in FIG. 4 according to the exemplary embodiment described above. The first variation of the motor unit 2 further includes an insulating member 65 provided for the first surface 611 of the board 61.

In the first variation, the thermally conductive member 76 and the metal layer 6181 are thermally connected to each other via the insulating member 65 and the resist layer 6191 interposed between the thermally conductive member 76 and the metal layer 6181.

The insulating member 65 has the function of reducing, by partially covering the through holes 614 provided through the board 61, the chances of a part of the solder 63 applied onto the second surface 612 flowing out toward the first surface 611 through the through holes 614. The part of the solder 63 flowing out onto the first surface 611 would cause a short-circuit and other inconveniences.

The insulating member 65 may be formed, for example, by printing a colored insulating resin onto the first surface 611 by so-called “screen printing” method. However, the screen printing is only an exemplary method for printing the insulating resin. Alternatively, any other suitable printing method such as so-called “inkjet printing,” UV printing using a UV curable insulating resin, or printing using a thermosetting insulating resin may also be adopted. If the insulating member 65 is formed by printing, the insulating member 65 is preferably printed onto the resist layers 6191, 6192 as the outermost layers of the board 61. Optionally, the work of printing the insulating resin may be performed multiple times on the same spot.

In the first variation, the insulating member 65 has a plurality of holes 653 corresponding one to one to the plurality of through holes 614. The holes 653 are circular holes penetrating through the insulating member 65. The outside diameter of each of the plurality of holes 653 is smaller than the outside diameter of its corresponding through hole 614. More specifically, the outside diameter of each hole 653 is smaller than the outside diameter of the opening on the first surface 611 of its corresponding through hole 614. The opening area of each hole 653 is smaller than the opening area of its corresponding through hole 614. When viewed along the direction in which the through hole 614 penetrates through the board 61, the opening edge of each hole 653 is located inside the opening edge of its corresponding through hole 614.

Note that the insulating member 65 does not have to have these holes 653 but may have no holes 653. In the latter case, the plurality of through holes 614 provided through the board 61 are closed by the insulating member 65. In some cases, only some of the plurality of through holes 614 provided through the board 61 may be closed by the insulating member 65.

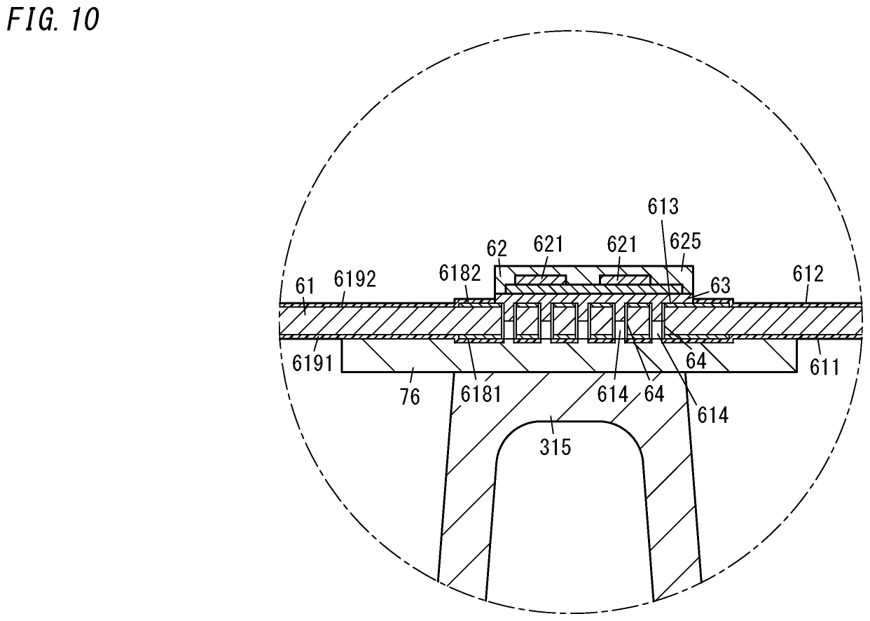

FIG. 10 illustrates a cross section of a principal part of a motor unit 2 according to a second variation. This principal part corresponds to the part shown in FIG. 4 according to the exemplary embodiment described above. In the second variation of the motor unit 2, the case 3 has no heat-dissipating portion 325 and no thermally conductive member 77 is provided inside the case 3, either. Each of the switching elements 62 does not have a direct heat-dissipating path with respect to the second divided part 32 of the case 3 but does have a direct heat-dissipating path through the sheet of metal foil 64 inside the plurality of through holes 614, for example, with respect to the first divided part 31 of the case 3.

In addition, in motor unit 2 according to the second variation, each switching element 62 includes a plurality of field effect transistors 621 and a package 625 which covers these field effect transistors 621. The switching element 62 of this type has superior heat dissipation properties to the switching element 62 of the type including a single field effect transistor 621 shown in FIG. 4.

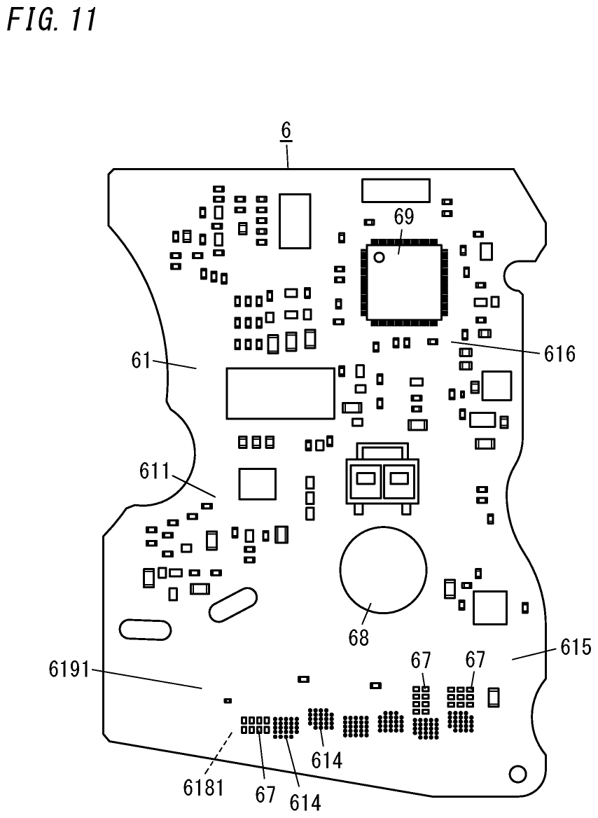

FIG. 11 illustrates a board 61 included in a motor unit 2 according to a third variation. The board 61 includes a resist layer 6191 as the outermost layer on the first surface 611 and a metal layer 6181 covered with the resist layer 6191. The metal layer 6181 is thermally connected to the sheet of metal foil 64 inside the plurality of through holes 614. The resist layer 6191 has been patterned to expose parts of the metal layer 6181. Heat-dissipating solder portions 67 are fixed to those exposed parts.

The solder portions 67 are thermally connected to the sheet of metal foil 64 inside the plurality of through holes 614 via the metal layer 6181 and are eventually thermally connected to the switching elements 62. In the third variation, a plurality of solder portions 67 are arranged in a matrix pattern around a portion, located opposite from each mounting surface 613, of the first surface 611 of the board 61, thus further improving the heat dissipation properties. The plurality of solder portions 67 are preferably thermally connected to the heat-dissipating portion 315 of the case 3 via the thermally conductive member 76 but may be directly in contact with the heat-dissipating portion 315.

Although the motor unit 2 according to the third variation includes the plurality of solder portions 67, the motor unit 2 may include at least one solder portion 67 to improve the heat dissipation properties of each switching element 62.

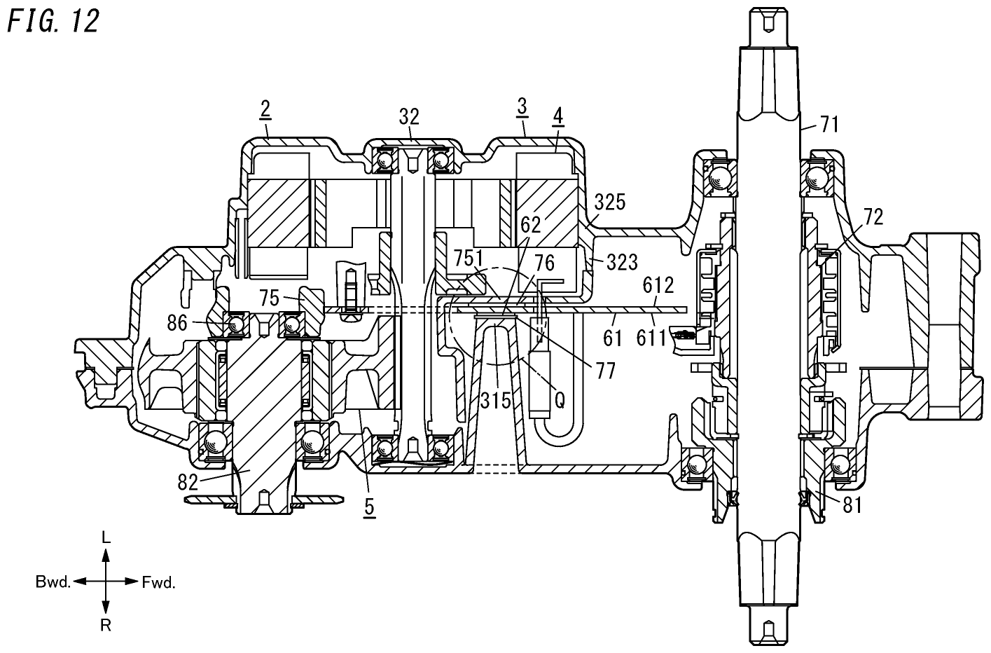

FIG. 12 illustrates a fourth variation of the motor unit 2. In this fourth variation, the metallic retainer 75 that holds the bearing 86 and other members includes, as an integral part thereof, a thermally conductive portion 751, which is interposed between the second divided part 32 of the case 3 and the thermally conductive member 76. In other words, the thermally conductive portion 751 which forms part of the retainer 75 housed in the case 3 is interposed between the second divided part 32 and the thermally conductive member 76 to thermally connect the second divided part 32 and the thermally conductive member 77 to each other.

In the fourth variation, a portion, surrounding the portion 323 to which heat is transmitted from the retainer 75, of the second divided part 32 constitutes the heat-dissipating portion 325 that may be exposed to the outside air.

Note that in this fourth variation, the switching elements 62 are mounted on the first surface 611 of the board 61. That is to say, in this fourth variation, the first surface 611 is a principal surface including the mounting surfaces 613 to mount the switching elements 62 thereon and the second surface 612 is the reverse surface facing opposite from the principal surface including the mounting surfaces 613.

In the fourth variation, the heat-dissipating portion 325 is the part that is located opposite from the switching elements 62 with respect to the board 61 and that is thermally connected to the sheet of metal foil 64 via the retainer 75 and other members. On the other hand, the heat-dissipating portion 315 is the part, located on the same side as the switching elements 62 with respect to the board 61, of the case 3 and that is thermally connected to the switching elements 62. The switching elements 62 are sandwiched between the board 61 and the heat-dissipating portion 315.

The motor unit 2 included in the electric bicycle 1 according to the exemplary embodiment described above may also have any of the following alternative configurations, besides the variations described above.

For example, the motor unit 2 according to the exemplary embodiment described above may include two or more electric field capacitors 68 mounted on the board 61. In that case, the two or more electric field capacitors 68 may be mounted on either only one of the first surface 611 or the second surface 612 of the board 61 or distributed on both of the first surface 611 and the second surface 612 of the board 61, whichever is appropriate. Providing two or more electric field capacitors 68 allows the electric field capacitors 68 to be arranged on the board 61 with an increased degree of freedom and also enables using the space inside the case 3 more effectively.

Also, the motor unit 2 according to the exemplary embodiment described above may further include an inertial sensor (not shown) mounted on the board 61. The inertial sensor may be, for example, an acceleration sensor, a tilt sensor, or a gyrosensor. The microcontroller 69 may control the motor 4 based on the output of the inertial sensor. The inertial sensor is preferably mounted on the second half 616 of the board 61. As described above, the second half 616 is the upper half of the board 61 and the mounting surfaces 613 are provided in the lower half (i.e., the first half 615) of the board 61.

In the motor unit 2 according to the exemplary embodiment described above, the motor 4 is located on the left-hand side of the board 61 (i.e., located on the second side). Alternatively, the motor 4 may also be located on the right-hand side of the board 61 (i.e., located on the first side).

In the motor unit 2 according to the exemplary embodiment described above, the base member, covered with the resist layers 6191, 6192, of the board 61 may also be made of a thermally conductive material. Examples of the thermally conductive material include metals such as aluminum and copper and ceramics. This enables further improving the heat dissipation properties of the switching elements 62 via the base member of the board 61.

In the motor unit 2 according to the exemplary embodiment described above, the speed reducer 5 is implemented as a single-stage speed reducer. Alternatively, a double-stage or triple-stage speed reducer may also be used as the speed reducer 5.

The motor unit 2 according to the exemplary embodiment described above is a so-called “biaxial motor unit” and includes, as two separate parts, the output body 81 to which the first sprocket 191 is coupled and which is rotatable and the output body 82 to which the second sprocket 192 is coupled and which is rotatable. Alternatively, the motor unit 2 may also be implemented as a uniaxial type. To implement the motor unit 2 as a uniaxial type, the speed reducer 5 may be configured to transfer the rotational power of the motor 4 to the output body 81. This allows both the rotational power of the input shaft 71 and the rotational power of the motor 4 to be transferred to the output body 81. In this case, the speed reducer 5 may also be implemented as a single-stage, double-stage, or triple-stage speed reducer.

In the motor unit 2 according to the exemplary embodiment described above, the heat-dissipating portion 315 forms an integral part of the first divided part 31. Alternatively, the heat-dissipating portion 315 may be provided separately from the first divided part 31. It is also preferable that the heat-dissipating portion 315 provided separately from the first divided part 31 be attached to the first divided part 31. In that case, a thermally conductive member having flexibility is preferably interposed between the first divided part 31 and the heat-dissipating portion 315 to increase the thermal conductivity between the first divided part 31 and the heat-dissipating portion 315.

In the motor unit 2 according to the exemplary embodiment described above, the heat-dissipating portion 325 forms an integral part of the second divided part 32. Alternatively, the heat-dissipating portion 325 may be provided separately from the second divided part 32. It is also preferable that the heat-dissipating portion 325 provided separately from the second divided part 32 be attached to the second divided part 32. In that case, a thermally conductive member having flexibility is preferably interposed between the second divided part 32 and the heat-dissipating portion 325 to increase the thermal conductivity between the second divided part 32 and the heat-dissipating portion 325.

The electric bicycle 1 according to the exemplary embodiment described above is a so-called “electric assist bicycle.” However, this is only an example and should not be construed as limiting. Alternatively, the electric bicycle 1 may also be implemented as an e-bike having the ability to drive the wheels 11 in rotation without the manual driving force. Furthermore, the electric bicycle 1 according to the exemplary embodiment described above includes two wheels 11. However, the number of the wheels 11 is not limited to any particular number but may also be three or more.

### (2) Alternative Embodiment

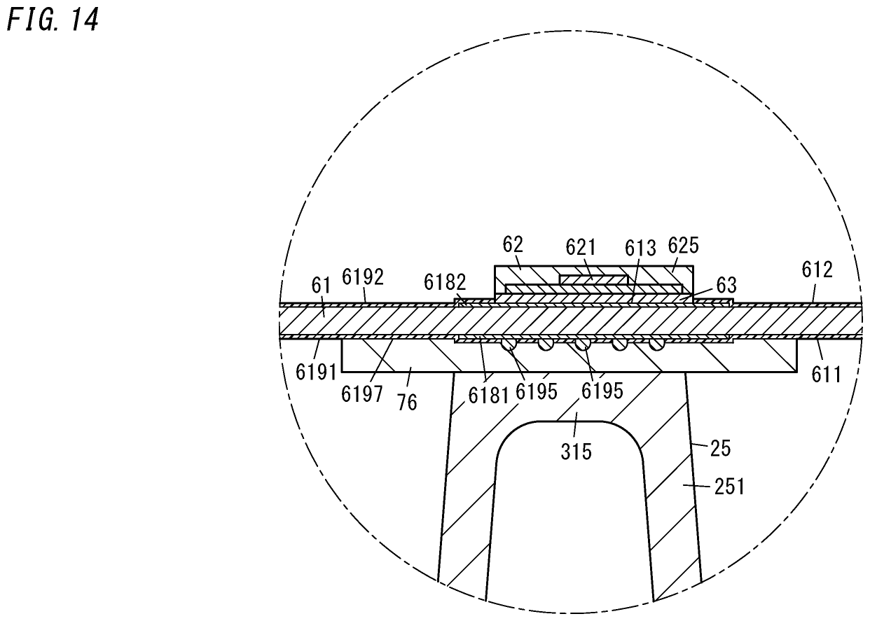

Next, a motor unit 2 according to an alternative embodiment will be described with reference to FIG. 14. In the following description, any constituent element of this alternative embodiment, having the same function as a counterpart of the exemplary embodiment described above, will be designated by the same reference numeral as that counterpart's, and a detailed description thereof will be omitted herein.

The motor unit 2 according to this alternative embodiment, as well as the motor unit 2 according to the exemplary embodiment described above, is also used in an electric bicycle 1 (see FIG. 1). The motor unit 2 is supported and mounted on the frame 10 of the electric bicycle 1. The rear wheel 112 of the electric bicycle 1 is driven in rotation by the driving force supplied from the motor unit 2 (i.e., upon receiving the rotational power of the motor 4 included in the motor unit 2).

The motor unit 2 includes, as in the exemplary embodiment described above, a motor 4, switching elements 62 for driving the motor 4, a board 61, and a case 3. The board 61 has a first surface 611 and a second surface 612. The second surface 612 is a surface including mounting surfaces 613 to respectively mount the switching elements 62 thereon. The first surface 611 is a reverse surface facing opposite from the second surface 612. The case 3 includes a first divided part 31 and a second divided part 32. A hollow case 3 is formed by joining together the first divided part 31 and the second divided part 32. The board 61 is housed in the case 3.

In the motor unit 2 according to this alternative embodiment, the board 61 has, unlike the exemplary embodiment described above, neither the through holes 614 nor the sheet of metal foil 64.

The board 61 includes a resist layer 6191 and a metal layer 6181. The resist layer 6191 defines the outermost layer of the first surface 611 and forms the first surface 611. The metal layer 6181 is covered with the resist layer 6191.

The resist layer 6191 is arranged to expose a part of the metal layer 6181. At least one metallic projection 6195 for dissipating heat is fixed to the exposed part. This resist layer 6191 serves as an insulating layer 6197 arranged to expose a part of the metal layer 6181.

The metallic projection 6195 may include solder, for example, and protrudes away from the board 61. The metallic projection 6195 is thermally connected to the metal layer 6181. The metallic projection 6195 is preferably in contact with the metal layer 6181.

In the motor unit 2 according to this alternative embodiment, a plurality of such metallic projections 6195 are provided for the part of the metal layer 6181. The plurality of metallic projections 6195 are arranged to be distributed on a part, opposite from an associated one of the mounting surfaces 613, of the first surface 611 of the board 61. The plurality of metallic projections 6195 are arranged to overlap with an associated one of the switching elements 62 when viewed perpendicularly to the first surface 611. In the motor unit 2 according to this alternative embodiment, these metallic projections 6195 improve the heat-dissipation properties of the switching element 62.

The motor unit 2 according to this alternative embodiment further includes a heat-dissipating portion 25 interposed between the switching elements 62 and the case 3. The heat-dissipating portion 25 is provided to transfer the heat generated by the switching elements 62 to the outer surface of the case 3.

The heat-dissipating portion 25 includes a first heat-dissipating portion 251. The first heat-dissipating portion 251 is configured as the heat-dissipating portion 315 of the first divided part 31.

The first heat-dissipating portion 251 is thermally connected to the plurality of metallic projections 6195 via a thermally conductive member 76 having the shape of a sheet with flexibility. The first heat-dissipating portion 251 is preferably in contact with the thermally conductive member 76. The thermally conductive member 76 is preferably in contact with the plurality of metallic projections 6195. The heat-dissipating portion 25 may form an integral part of the case 3 or at least part of the heat-dissipating portion 25 may be provided separately from the case 3, whichever is appropriate. That is to say, the first heat-dissipating portion 251 may form an integral part of the case 3 (more specifically, the first divided part 31 thereof) or be provided separately from the case 3, whichever is appropriate.

Next, a variation of the motor unit 2 according to this alternative embodiment will be described.

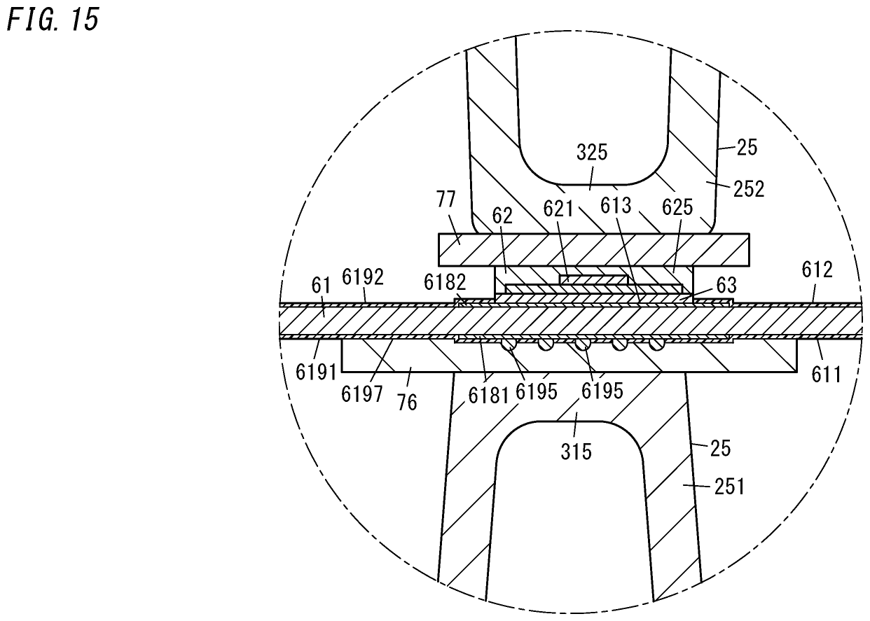

FIG. 15 illustrates a variation of the motor unit 2 according to this alternative embodiment. In this variation, the heat-dissipating portion 25 includes not only the first heat-dissipating portion 251 but also a second heat-dissipating portion 252 as well. The second heat-dissipating portion 252 is configured as the heat-dissipating portion 325 of the second divided part 32.

The second heat-dissipating portion 252 is thermally connected to the plurality of switching elements 62 via a thermally conductive member 77 having the shape of a sheet with flexibility. The second heat-dissipating portion 252 is preferably in contact with the thermally conductive member 77. The thermally conductive member 77 is preferably in contact with the plurality of switching elements 62. The heat-dissipating portion 25 may form an integral part of the case 3 or at least part of the heat-dissipating portion 25 may be provided separately from the case 3, whichever is appropriate. That is to say, the second heat-dissipating portion 252, as well as the first heat-dissipating portion 251, may form an integral part of the case 3 (more specifically, the second divided part 32 thereof) or be provided separately from the case 3, whichever is appropriate.

Although the motor unit 2 according to this alternative embodiment includes a plurality of metallic projections 6195, the motor unit 2 may include at least one metallic projection 6195 to improve the heat-dissipation properties of each of the switching elements 62. Also, in this embodiment, the metallic projection 6195 is made of solder. However, this is only an example and should not be construed as limiting. Alternatively, the metallic projection 6195 may also be made of any other metal such as copper, iron, or aluminum, instead of solder.

In the motor unit 2 according to this alternative embodiment, the plurality of metallic projections 6195 are arranged to overlap with an associated one of the switching elements 62 when viewed perpendicularly to the first surface 611. Alternatively, the plurality of metallic projections 6195 may also be arranged not to overlap with the switching elements 62 when viewed perpendicularly to the first surface 611. Still alternatively, at least one of the plurality of metallic projections 6195 may be arranged to overlap with the switching element 62 when viewed perpendicularly to the first surface 611 and at least another one of the plurality of metallic projections 6195 may be arranged not to overlap with any of the switching elements 62 when viewed perpendicularly to the first surface 611.

Note that the exemplary embodiments and their variations described above are only exemplary ones of various embodiments of the present disclosure and their variations and should not be construed as limiting. Rather, the exemplary embodiments and their variations may be readily modified or combined as appropriate in various manners depending on a design choice or any other factor without departing from the scope of the present disclosure.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A motor unit for use in an electric bicycle, the motor unit comprising:
a motor;
a switching element configured to have the motor driven;
a board having: a principal surface including a mounting surface to mount the switching element thereon; and a reverse surface facing opposite from the principal surface; and
a case housing the board therein,
the board further having: a through hole provided to penetrate through the board from the mounting surface through the reverse surface; and a sheet of metal foil covering an inner peripheral surface of the through hole at least partially,
the switching element being thermally connected to the sheet of metal foil,
a part, located opposite from the switching element with respect to the board, of the case being thermally connected to the sheet of metal foil.

2. The motor unit of claim 1, further comprising solder to fix the switching element onto the mounting surface, wherein
the switching element is thermally connected to the sheet of metal foil via the solder.

3. The motor unit of claim 2, further comprising an insulating member provided on the reverse surface to cover the through hole at least partially.

4. The motor unit of claim 1, wherein
the through hole has a diameter falling within a range from 0.2 mm to 0.4 mm.

5. The motor unit of claim 1, wherein
the motor is located on the same side as the switching element with respect to the board.

6. The motor unit of claim 1, wherein
the sheet of metal foil has a thickness falling within a range from 10 μm to 30 μm.

7. The motor unit of claim 1, wherein
the board includes a base member made of a thermally conductive material.

8. The motor unit of claim 1, wherein
a part, located on the same side as the switching element with respect to the board, of the case is thermally connected to the switching element.

9. The motor unit of claim 1, wherein
the board includes a metal layer and a resist layer covering the metal layer,
the metal layer is thermally connected to the sheet of metal foil,
the resist layer is arranged to expose a part of the metal layer, and
a heat-dissipating solder portion is fixed to the part of the metal layer.

10. The motor unit of claim 1, wherein
the through hole has an opening and the switching element faces the opening.

11. The motor unit of claim 1, further comprising two or more electric field capacitors mounted on the board.

12. The motor unit of claim 1, further comprising an inertial sensor and/or a microcontroller which are/is mounted on a first half of the board, wherein
the mounting surface is located in a second half of the board.

13. The motor unit of claim 1, further comprising a microcontroller mounted on the board, wherein
the microcontroller is arranged not to overlap with the motor when viewed along a center axis of rotation of the motor.

14. The motor unit of claim 1, comprising:
an input shaft, to which crank arms are coupled and which is rotatable;
a first output body, to which a first sprocket is coupled and which is rotatable; and
a second output body, to which a second sprocket is coupled and which is rotatable, wherein
the first output body is configured to receive rotational power transmitted from the input shaft, and
the second output body is configured to receive rotational power transmitted from the motor.

15. The motor unit of claim 1, comprising:
an input shaft, to which crank arms are coupled and which is rotatable; and
an output body, to which a sprocket is coupled and which is rotatable, wherein
the output body is configured to receive rotational power transmitted from the input shaft and rotational power transmitted from the motor.

16. A motor unit for use in an electric bicycle, the motor unit comprising:
a motor;
a switching element configured to have the motor driven;
a board having: a principal surface including a mounting surface to mount the switching element thereon; and a reverse surface facing opposite from the principal surface;
a case housing the board therein; and
a heat-dissipating portion interposed between the switching element and the case to transfer heat generated by the switching element to an outer surface of the case,
the board including: an insulating layer forming the reverse surface; and a metal layer covered with the insulating layer,
the insulating layer being arranged to expose a part of the metal layer,
the part of the metal layer being provided with a metallic projection protruding away from the board.

17. The motor unit of claim 16, wherein
the heat-dissipating portion includes a first heat-dissipating portion thermally connected to the metallic projection via a thermally conductive member.

18. The motor unit of claim 16, wherein
the metallic projection is arranged to overlap with the switching element when viewed perpendicularly to the reverse surface.

19. The motor unit of claim 16, wherein
the heat-dissipating portion includes a second heat-dissipating portion thermally connected to the switching element via a thermally conductive member.

20. The motor unit of claim 16, wherein
at least part of the heat-dissipating portion is provided separately from the case.
